(19) United States
(12) Patent Application Publication
(10) Pub. No.: US 2001/0026101 A1
(43) Pub. Date: Oct. 4, 2001

(54) Variable reluctance motor

(76) Inventors: Stanislaw Wladyslaw Janisiewicz, Endwell, NY (US); Darrin Michael Weiss, Vestal, NY (US); Andrew Zalesski, Apalachin, NY (US); Koen Alexander Gieskes, Binghamton, NY (US)

Correspondence Address: BANNER & WITCOFF, 1001 G STREET N W, SUITE 1100, WASHINGTON, DC, 20001, US

(21) Appl. No.: 09/820,766

(22) Filed: Mar. 30, 2001

Related U.S. Application Data
(63) Continuation-in-part of application No. 09/538,898, filed on Mar. 30, 2000, now abandoned.

(51) Int. Cl. H02K 41/00

(52) U.S. Cl. 310/12

(57) ABSTRACT

A high power, low cost magnetically uncoupled variable reluctance motor that provides increased performance while reducing hysteresis losses, thereby reducing the amount of generated heat that needs to be drawn away from a phase assembly. The motor includes a linear or rotary variable reluctance motor that has at least one phase assembly including a plurality of phase units that are magnetically isolated from each other. At least one phase unit includes at least one module removably positioned between a pair of housing plates. By removably positioning the modules between the housing plates, the number of modules within the phase assembly can be adjusted so that the motor produces a desired power output. In one embodiment, each module has a substantially C-shape that includes a pair of legs, each positioned on one side of a main body portion. An electrically conductive coil is positioned about the main body portion and arranged in a substantially V-shape. A bobbin carries the coil and maintains it in the substantially V-shape. The portion of the V-shaped bobbin having the largest surface area permits the positioned coil to be spread out over a large surface area so that heat is easily and efficiently dissipated. The direction of the magnetic flux in the adjacent phase units is opposite to reduce hysteresis losses in the stator.

The present invention relates to a variable reluctance motor, and more particularly, to a variable reluctance motor comprising n substantially identical phase modules, wherein n is selectable to match power requirements of the motor.

### BACKGROUND OF THE INVENTION

Variable reluctance motors can be used as direct drive motors for machines that perform repeated applications requiring a high degree of accuracy. These motors can include phase assemblies (motor cores) and elongated stators that control the movement of tools such as robotic arms and placement heads along a first axis and a second axis. During the operation of certain machines, each phase assembly and its respective stator move relative to each other via magnetomotive force. Magnetic flux is generated in motor cores of each phase assembly in response to an electrical current flowing through coils wrapped about portions of the motor cores. The relative movement between each motor core and its stator causes the related robotic arm or placement head to move from a first position to a second position. This position-to-position movement must be completed with a high degree of precision and at a high velocity under varying load conditions.

Each variable reluctance motor is designed to deliver a corresponding specified power output. The specified power output depends on the load conditions under which a motor will operate. According to conventional techniques, in order to assemble a variety of variable reluctance motors, each having different power outputs, a variety of motor core structures must be produced, each structure's size corresponding to a specified motor power requirement. The cost of assembling motor cores is adversely impacted by the requirement for stamping tools of different sizes to produce appropriately sized cores.

### SUMMARY OF THE INVENTION

The invention provides a variable reluctance motor comprising at least one phase assembly. The phase assembly comprises n substantially identical phase modules, wherein n is the total number of substantially identical phase modules comprising the phase assembly. The number n is selectable in accordance with a power requirement of the motor. The invention further provides a phase module configured to maximize cooling and to minimize heat dissipation in the motor.

### BRIEF DESCRIPTION OF THE DRAWINGS

FIG. 1 is an isometric view of a modular variable reluctance motor including a phase assembly with top plate removed according to the present invention;

FIG. 2 is a partial exploded isometric view of the phase assembly shown in FIG. 1 including base and top plates;

FIG. 3 is a top view of a phase unit of the motor of FIG. 1, with a stator interposed between phase modules;

FIG. 4 is an isometric view of a phase module of a phase unit of the motor according to the present invention;

FIG. 5 is an isometric view of a portion of a bobbin according to the invention;

FIG. 6 is a diagram of flux paths through three phase units and a stator according to an embodiment of the invention;

FIG. 7 is a diagram of flux paths through three phase units and a stator according to an alternative embodiment of the present invention;

### DETAILED DESCRIPTION OF THE DRAWINGS

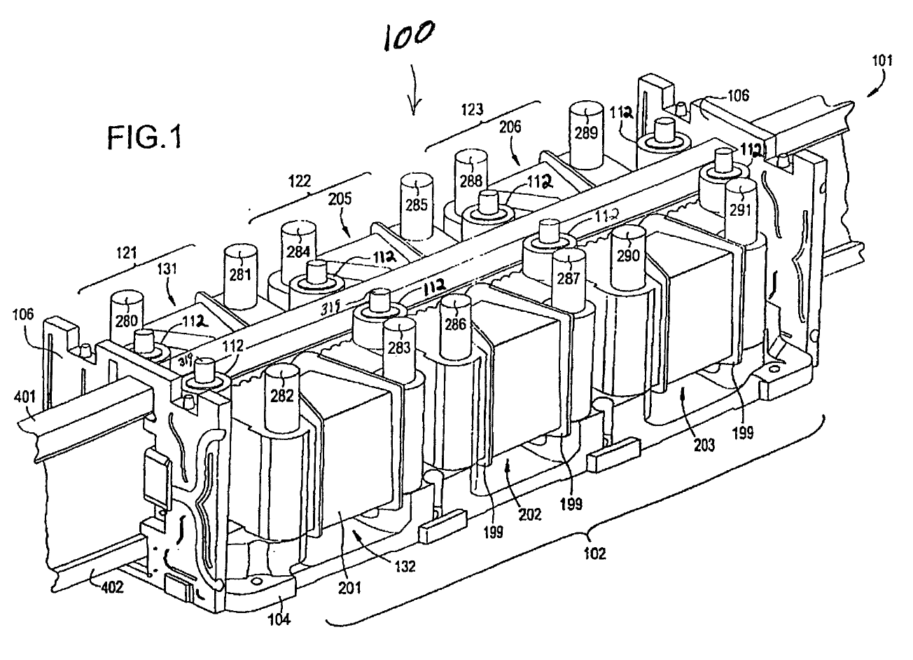

FIG. 1 illustrates a variable reluctance motor 100 that comprises a stator (stator bar) 101 and at least one phase assembly 102 according to the present invention. In one embodiment, linear variable reluctance motor 100 is used with a machine that receives and positions components in a substrate. Such machines are commonly referred to as “pick and place machines” and examples are disclosed in U.S. Pat. Nos. 5,852,869 and 5,649,356. Although the present invention is described with respect to a pick and place machine, its use is not limited only to this machine. Instead, it can be incorporated into any machine that requires high velocity movements that must be completed with a high degree of accuracy. Additionally, the present invention is not limited to linear, variable reluctance motors. Instead, the present invention is applicable to both linear and rotary variable reluctance motors that operate as servo motors so that any desired position can be achieved. In another embodiment, the motor operates as a stepper motor.

In one embodiment of variable reluctance linear motor 100, a phase assembly 102 is configured to move along the longitudinal axis of the stator 101 while the position of the stator 101 is fixed against movement, as discussed below and illustrated in FIG. 1. In an alternative embodiment the stator 101 slides within the phase assembly 102 while the position of the phase assembly 102 is fixed against movement. As used herein, the term “configured” means operatively arranged so as to perform a specified function.

As illustrated in FIG. 1, phase assembly 102 moves relative to the stator 101 in response to the application of a magnetomotive force. In this embodiment, the stator 101 is fixed in position and the phase assembly 102 moves along the length of the stator 101 during the operation of the motor 100. According to one embodiment of the motor 100, when motion is required in more than one plane, a plurality of phase assemblies and stators are employed. For example, a first phase assembly moves relative to a first stator in a direction parallel to a first axis and a second phase assembly moves relative to a second stator in a direction that extends parallel to a second axis. Translational movement of the phase assembly 102 along its stator 101 is controlled by selectively applying electrical current to one or more phase units. One example of a controller suitable for use in the present invention is described in U.S. Pat. No. 5,621,294.

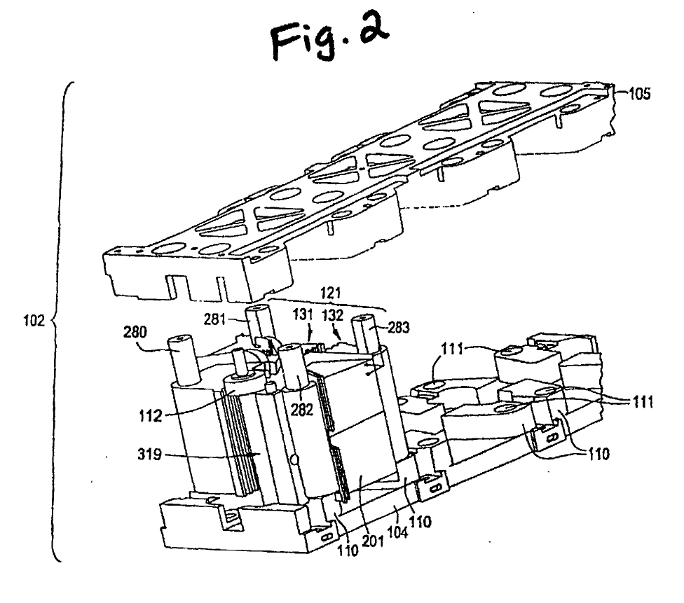

As shown in FIG. 2, each phase assembly 102 includes stator guide bearings 112, housing plates 104 and 105, pre-formed bosses 110 with wells 111, and end pieces 106 (best illustrated in FIG. 1). Each phase assembly 102 also comprises at least one phase unit 121-123 (best illustrated in FIG. 1.) In alternative embodiments, the motor 100 includes between two and seven phase units depending on the desired number of phases of motor 1100, and upon the accuracy and power requirements of the pick and place machine in which motor 100 is employed. Other embodiments use other numbers of phase units depending upon power requirements, cost, and size considerations.

In one embodiment of the invention, phase units 121-123 are substantially identical units. The number (n) of phase units comprising a given phase assembly is chosen according to the power requirements of motor 100. The greater the required power the more substantially identical phase units are installed in a phase assembly. Because the phase units are substantially identical, assembly of a variety of phase assemblies having different power capabilities can be achieved by utilizing different numbers of substantially identical parts. This simplifies the manufacture of the phase assembly and achieves significant cost savings.

In an alternative embodiment of the invention, phase units 121-123 are modular phase units. As defined herein, “modular” means comprising removable and replaceable sections (phase modules). In one embodiment, the phase units 121-123 are also interchangeable. Each phase unit 121-123 comprises two opposing paired phase modules 131, 132; 205, 202; 206, 203, respectively. In an alternative embodiment, each phase unit comprises more than two phase modules, for example, each phase unit comprises two sets of opposing pairs of phase modules, i.e., four modules per phase unit.

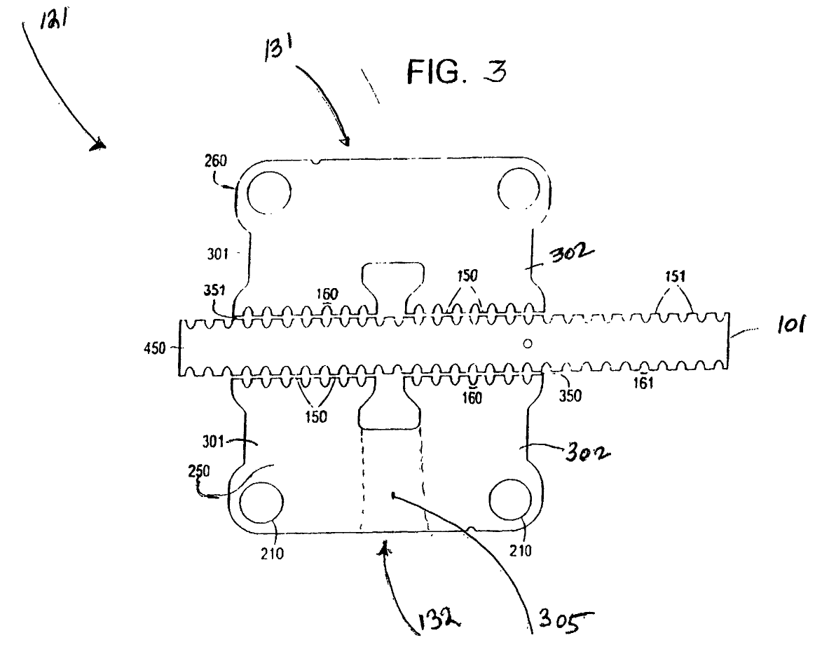

In both embodiments, the modules of each phase unit face each other from opposite sides of the stator 101. The modules are substantially identical, spaced apart and secured to base housing plate 104 and top housing plate 105 in substantially mirror image positions. The modules are separated from each other by the stator 101 (best illustrated in FIG. 3). For example, phase unit 121 comprises modules 131 and 132 that face each other across stator 101. The same is true of phase unit 122 that comprises modules 205 and 202, and phase unit 123 that comprises modules 206 and 203.

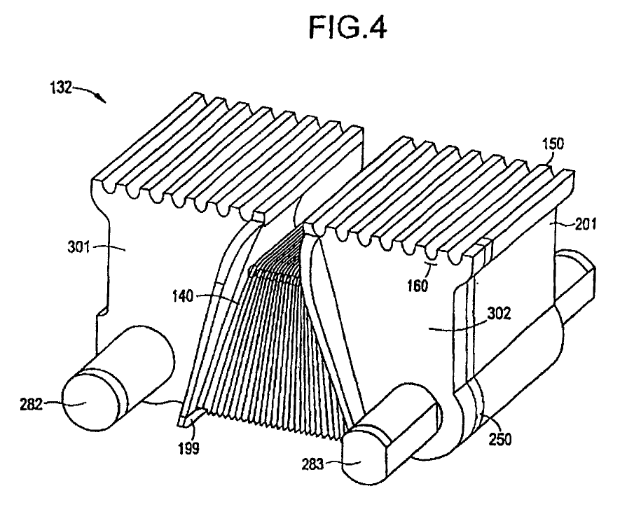

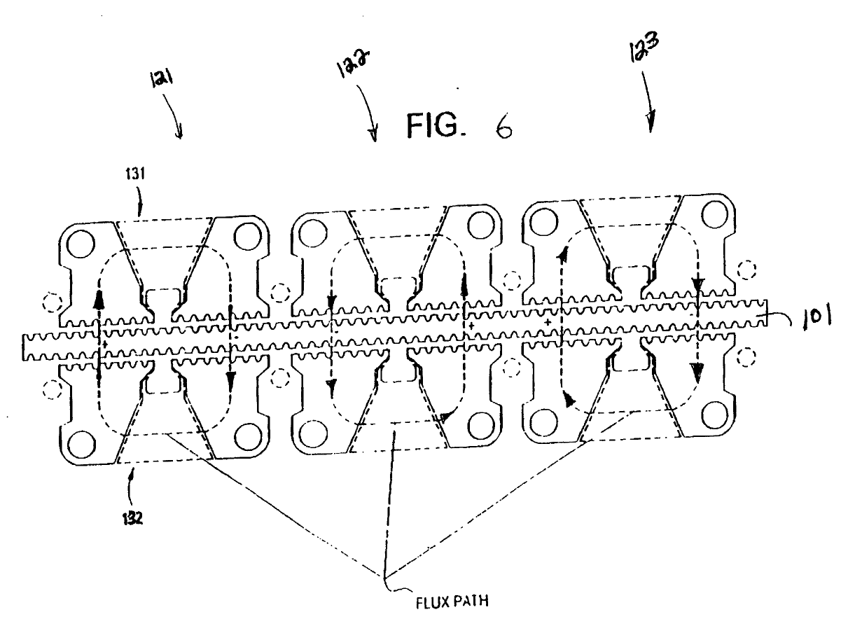

While the present invention includes embodiments with one phase module and embodiments with a plurality of phase modules, only one phase module will be described for ease of explanation. An example module 132 is shown in FIG. 4. The description of module 132 is equally applicable to the other modules of the present invention. Module 132 comprises a core 201, and in one embodiment module 132 further comprises a pair of shafts 282 and 283 two shafts of 280-291 as illustrated in FIG. 1. In one embodiment of the invention, core 201 comprises a stack of laminations 250. In one embodiment of the invention the core 201 is formed of silicon iron. Other embodiments include cores formed of other ferromagnetic materials. In one embodiment module 132 includes a bobbin 199 (best illustrated in FIG. 6) that is formed of a non-conductive material, as discussed below. Alternative embodiments, however, do not include a bobbin 199. Module 132 further includes a wire coil 140 comprising at least one winding positioned around core 201. In one embodiment, the wire coil 140 includes about 100 windings.

In one embodiment, core 201 is substantially C-shaped. In an embodiment in which core 201 comprises laminations 250, laminations 250 are referred to herein as “C-core laminations 250”. A single lamination 250 is illustrated in FIG. 3. As shown in FIG. 4 each core 201 includes a pair of legs 301, 302 that extend from a center section 305 (best illustrated in FIG. 3) in the direction of the stator 101 when the motor 100 is assembled. Each leg 301, 302 comprises a plurality of teeth 150. In an embodiment comprising C-core laminations 250, when core laminations 250 are secured together, core 201 includes rows of teeth 150 separated by rows of grooves 160 as shown in FIG. 4. Core 201 of each module is fabricated using a ferromagnetic material. In one embodiment, the material is silicon iron. Another suitable material is a cobalt-iron alloy, for example, HIPERCO® available from CARPENTER®.

In an embodiment in which core 201 comprises core laminations 250, adjacent stacked core laminations 250 are fixed together to prevent their relative movement. Various methods for fixing the stacked laminations 250 together include using a clamp, welding with a laser, staking, or bonding with a non-conductive epoxy. Other methods for securing the laminations 250 together can also be employed. In one embodiment, each stacked C-core lamination 250 is bonded to an adjacent lamination 250 by a non-conducting bonding epoxy that is applied by submerging each lamination 250 of the stack 201 in a bath of this epoxy in an impregnation fixture. In one embodiment, EP19 HT-FL(SP) 85-15 Flexiblize Mix, available from Master Bond® Polymer System, is an acceptable epoxy for securing adjacent laminations 250 together.

One conventional method of securing the C-core laminations 250 together in stack 201 is by vacuum impregnation. The number of C-core laminations 250 that are secured together to form the stack 201 can be varied in order to vary stack thickness. In one embodiment of the present invention, a stack 201 includes about one hundred forty to about two hundred fifty secured laminations 250. In another embodiment, one stack 201 includes about two hundred-fourteen secured C-core laminations 250. Each of these laminations 250 is between about ten and twenty mils thick. In one embodiment, the thickness for each lamination 250 is about fourteen mils. In one embodiment, a stack of C-core laminations 250 in a module moving along a first axis comprises two-thirds the total number of C-core laminations 250 as a module moving along a second axis. The greater the stack height 201, the more force produced by the module 131.

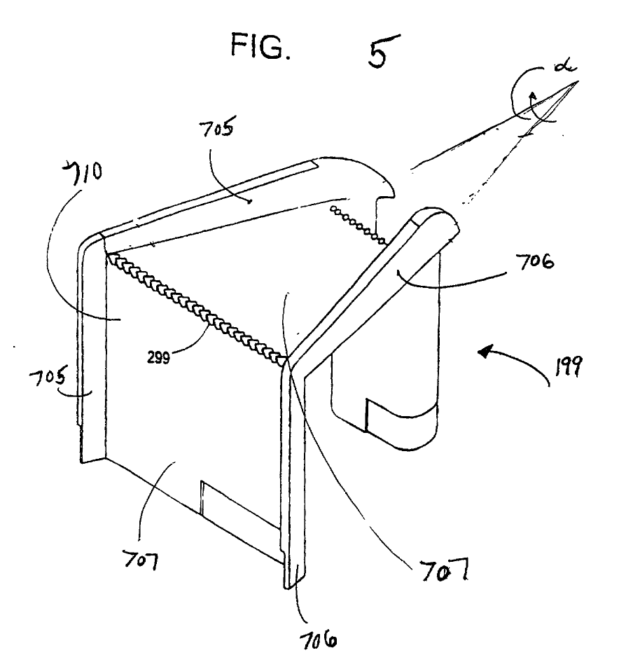

Wire coil 140 is formed by winding a wire at least one time, i.e., at least one turn, around bobbin 199 at the center of module 132. As used herein one winding is one turn of wire coil 140. Wire coil 140 is guided by the bobbin 199, which fits securely around the center of stack 201 as seen in FIG. 4. In one embodiment, the bobbin 199, partially depicted in FIG. 5, includes grooves 299 on its outer surface for receiving coil 140. The wound coil 140 is positioned by bobbin 199 in a generally fan shape. The fan shape spreads the coil windings over the largest possible surface area so that the number of winding layers is minimized. For example, in one embodiment of the invention the fan shape results in the formation of only a few, e.g. one or two, winding layers on an outer surface 710 of the bobbin 199, as shown in FIG. 5. An alternative embodiment includes four winding layers on outer surface 710.

The large surface area of the bobbin 199 and the small number of winding layers on the surface of bobbin 199 contributes to the quick dissipation of the heat generated by the coil 140 when compared to the prior art as discussed below. Other embodiments, however, include more winding layers yet still permit heat to be quickly dissipated. The modules of the present invention, as shown in the figures, are capable of being positioned closer together than the units of the prior art, thereby reducing the overall size of the motor 100 compared to prior art motors. Similarly, the present invention permits more modules to be positioned in the same amount of space than does the prior art.

As illustrated in FIGS. 4 and 5, bobbin 199 has a fan-like shape and is positioned about the center 305 of the stack 201 of C-core laminations 250. From the view shown in these figures, the bobbin 199 has a substantially V-shape and includes first and second sidewall 705, 706 respectively spaced on opposite sides of a main body portion 707 that includes a plurality of coil organizing grooves 299. The sidewalls 705, 706 each form an angle α, shown in FIG. 5, coil 140 to spread out when it is wound upon bobbin 199. In a first embodiment, the angle α, created by the sidewalls 705 and 706, is between about 0 and about 80 degrees. In another embodiment, the angle is about 30 degrees.

The bobbin 199 is formed of a conventional insulating material. In one embodiment, bobbin 199 is made of non-ferromagnetic and non-conductive materials such as plastics. In another embodiment, the materials used to form the bobbin 199 include liquid crystal polymers. Bobbin 199 in one embodiment of the invention is formed separate of the stack 201 and positioned over the stack 201 during the assembly of the motor. In another embodiment, the bobbin 199 is molded directly on and over the stack 201. Additionally, in another embodiment, known insulating materials are positioned between the coil 140 and the stack 201 in place of the bobbin 199.

As seen in FIG. 2, the plates 104, 105 positioned on either side of the phase modules are located in planes that extend parallel to each other and comprise the housing of the phase assembly 102. End pieces 106, as shown in FIG. 1, are removably attached to the base housing plate 104 and the top housing plate 105. In one embodiment, the end pieces 106 may include oil-saturated felt wipers (not shown) that lubricate the rails 401, 402 of the stator for low friction rolling engagement with stator guide bearings 112. In an embodiment, the end pieces 106 support a motion brake sensor of the type described in U.S. Pat. No. 5,828,195 entitled “Electronic Brake for a Variable Reluctance Motor”.

As shown in FIG. 2, the housing plates 104 and 105 are provided with pre-formed bosses 110 having integrally formed wells 111 for receiving and securely retaining shafts 280-291 extending through and outwardly from the stack 201 of C-core laminations 250 of each module. The shafts 280-291 are securely and rigidly received within the bosses 110 so that the shafts 280-291 are not moveable relative to housing plates 104, 105. The shafts 280-291 receive the force applied to their respective stack 201 by the stator 101 and, as a result of their rigid, non-flexible connection to the housing plates 104, 105, transfer substantially all of the forces applied to the stacks 201 by the stator 101 to the housing plates 104, 105. By reducing the forces transferred to bearings 112, the life of the motor is increased relative to prior art motors.

In one embodiment, each module is retained by press fitting its respective pair of the shafts 280-291 into the wells 111 of the base plate 104 and the top plate 105. Preferably, shafts 280-291 are made of non-ferromagnetic material. Shafts 280-291 are securely fitted through holes 210 in laminations 250 and are used to position the module 131 in the wells 111 of the housing plates 104, 105 of the phase assembly 102. The base and the top plates 104, 105 are configured to provide fixed locations for removable placement of the modules and the stator guide bearings 112. In one embodiment of the invention of motor 100, plates 104, 105 are designed so that modules can be repeatedly added to phase assembly 102 or removed from phase assembly 102 to adjust the characteristics of the motor 100. This provides the ability to change the number of modules within the phase assembly 102 without having to change the structure of either plate 104, 105.

The press fit relationship of the shafts 280-291 within each plate 104, 105 makes the assembly of the phase assembly 102 fast, reliable and easy. The press fit improves the tolerance of the phase assembly housing by reducing the accuracy requirements of the cooperating shaft and housing plate. In one embodiment comprising two phase assemblies, one of the three illustrated phase assemblies is removed by the steps of removing the top housing plate 105 and withdrawing the shafts of the eliminated phase unit from the base housing plate 104. After the eliminated phase unit has been taken out of the phase assembly 102, the housing of the phase assembly 102 is reconstructed by positioning top housing plate 105 over the remaining shafts 280-291 of the remaining phase units and securely fitting the housing plates 104, 105 together. Conversely, to add a phase unit to a phase assembly 102, housing plates 104 and 105 are separated and the shafts of the new phase unit positioned within corresponding wells 111 in base housing plate 104. After the inserted phase unit is secured to the base housing plate 104, the top housing plate 105 is positioned over it so that the shafts of the new phase unit are also received in their respective wells 111. The housing plates 104, 105 are then secured together against relative movement by being press fitted onto the shafts of all of the phase units under pressure. Alternatively, conventional ways of securing the plates 104, 105 together can be used. These conventional ways include, but are not limited to, removable fasteners. Although the above procedure describes that the top housing plate 105 is removed first, this is for purpose of explanation only. The above procedure can be performed by first separating the base housing plate 104 from the phase units.

Instead of removing an entire phase unit, one embodiment of the present invention provides for one module of a particular phase unit or all the phase units to be removed by the procedure discussed above. Further, it is also possible for the phase assembly 102 to be expanded beyond the capacity of its original housing plates 104, 105. In this instance, new plates 104, 105 having more bosses 110 and wells 111 for receiving the shafts of the additional phase units will be positioned on the shafts of the existing phase units and then the additional phase units can be inserted as discussed above.

In one embodiment of the invention stator 101, like stack 201, is formed from a plurality of plates (laminations) fixed together to prevent relative movement of the stator plates and to ensure structural integrity. The stator 101 can be formed in accordance with conventional practice and of the same material as the laminations 250. An alternative method of forming stator 101 is disclosed in co-pending U.S. patent application entitled “MOTOR INCLUDING IMPROVED STATOR” to Koenraad Gieskes et al.

As shown in FIG. 1, stator 101 is slidably coupled to its corresponding phase assembly 102 by at least one set of stator guide bearings 112. In the illustrated embodiment, each phase unit 121-123 has associated therewith eight stator guide bearings 112, four associated with each module. The guide bearings 112 rotate as the stator 101 and phase assembly 102 move relative to each other during the operation of the motor 100. The stator guide bearings 112 roll in contact with the flat, smooth surface of the stator rails 401 and 402 as phase assembly 102 moves longitudinally along the stator 101. The stator guide bearings 112 are interposed between the stator 101 and the modules to prevent contact between the stator 101 and the modules.

As seen in FIG. 3, air gaps 350, 351 separate the stator 101 from the modules in a phase unit. The size of air gaps 350, 351 on one side of the stator 101 is preferably the same as on the other side of the stator 101. In other words, the stator 101 is preferably centered between opposing modules of a phase unit. A positioning system for spacing the modules at equal distances from stator 101 in order to create symmetry about the stator is discussed in a copending U.S. patent application entitled ‘METHOD AND APPARATUS FOR REDUCING NOISE IN VARIABLE RELUCTANCE MOTORS” to Koenraad A. Gieskes et al. In that positioning system, the guide bearings 112 are held on compliant shafts 319 so that a space between opposing bearings 112 that receives stator 101 is slightly smaller than the width of the stator 101 as shown in FIG. 2.

Compliancy of shafts 319 results in a controlled mechanical force applied to stator 101 through bearings 112. For purposes of this specification, compliant, is defined as yielding to force. Shafts 319 are compliant such that pressure is applied against stator 101. In one embodiment, a force of about 100 lbs. per bearing 112 is applied against the stator 101 when the stator 101 is positioned between the bearings 112. The force maintains the position of the stator 101 and overcomes manufacturing variations. The stator guide bearings 112 adjust the location of the stator 101 so that same sized air gaps 350, 351 shown in FIG. 3, are formed on either side of the stator 101. It has been found that selecting this distance so that each of the paired modules is spaced equidistant from the stator 101 creates symmetry about the stator 101 and reduces the amount of vibration and acoustic noise created during the operation of the variable reluctance motor.

In one embodiment, each guide bearing 112 includes a typical ball bearing. Other known types of bearings and bearing surfaces that permit movement of the stator 101 relative to the phase assembly 102 can also be used. Examples include bearings having fluid between inner and outer bearing surfaces. Additional examples include bearings that include dry metal lubricants on at least one of their bearing surfaces.

The amount of force generated by phase assembly 102 is adjustable in several ways. A first way includes increasing or decreasing the number of laminations 250 in stack 201. A second way includes adjusting the number of windings of the coil 140 about the bobbin 100. A third way includes adjusting the amount of current through the wire coil 140. Fourth and fifth ways include adjusting the number of modules per phase unit and the number of phase units in the phase assembly 102, respectively. Any combination of these ways can also be used to adjust the force of the motor 100.

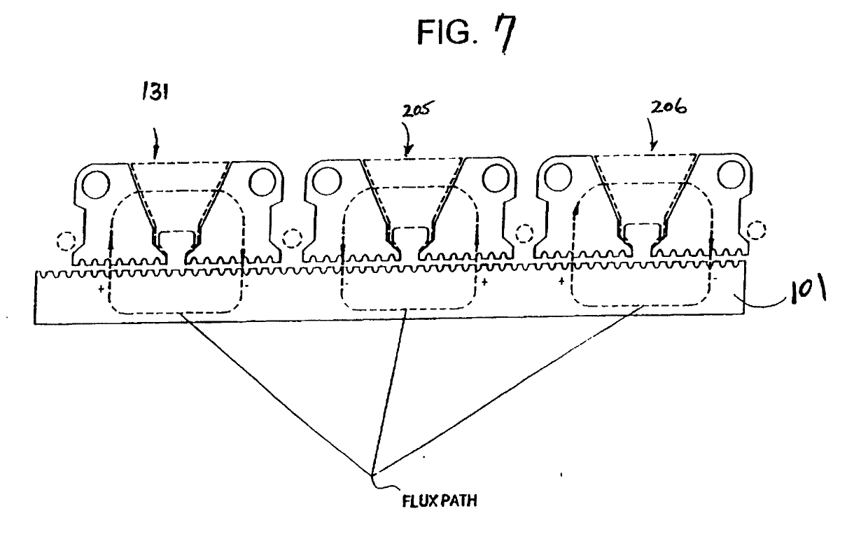

Each phase unit comprises at least one of the modules described above. In one embodiment phase assembly 102 comprises at least one unpaired module 131 as shown in FIG. 7. In this embodiment, the at least one unpaired module 131 is positioned adjacent to the stator 101. In an alternative embodiment, phase assembly 102 comprises paired modules 131,132 as shown in FIG. 6. In the alternative embodiment the two paired modules that form a phase unit are placed on opposite sides of the stator 101 as described herein.

Referring now to the exemplary embodiment shown in FIG. 6, magnetic flux flows in only one direction (i.e., either clockwise or counter-clockwise) within a given phase unit in conjunction with stator 101. As discussed above, the adjacent phase units are substantially electrically and magnetically isolated from each other, i.e., uncoupled, along the same side of the stator 101. The electrical current through coil 140 of any given module is adjustable at any given translational position. Maintaining a constant magnetic flux direction within a module minimizes hysteresis losses in the module core. In an alternative embodiment using unpaired modules, as shown in FIG. 7, the flux flows through each individual module 131 and stator 101 as a complete circuit.

Hysteresis losses are proportional to the frequency of directional change of the magnetic flux. Therefore, in one embodiment of the invention, the flux direction in adjacent phase units 121-123 is alternated, in order to lower hysteresis losses in the stator. For example, as shown in FIG. 6, the flux for phase unit 121 is in a clockwise direction, the flux for phase unit 122 is in a counter-clockwise direction, and the flux for phase unit 123 is in a clockwise direction. In another embodiment, the flux for phase unit 121 is in a counter-clockwise direction, the flux for phase unit 122 is in a clockwise direction and the flux for phase unit 123 is in a counter-clockwise direction.

As used herein, ferromagnetic material means any material possessing or exhibiting ferromagnetic properties, as that term is commonly understood, sufficient to make the material suitable for use in the present invention as described herein. The designations top and base are for reference purposes only and are not intended to be limiting on the position of the housing plates 104,105 or the orientation of the phase assembly 102.

While the above description contains many specifics, these should not be construed as limitations on the scope of the invention, but rather as an exemplification of one preferred embodiment thereof. Other variations are possible. Accordingly, the scope of the present invention should be determined not by the embodiments illustrated above, but by the appended claims and their legal equivalents.

We claim:

1. A variable reluctance motor comprising:
at least one phase assembly comprising n substantially identical phase modules, wherein n is the number of substantially identical phase modules and wherein n is selectable in accordance with a power requirement of said phase assembly.

2. The variable reluctance motor of claim 1 wherein n is selected prior to initial assembly of said phase assembly, and wherein n remains unchanged over the life of said phase assembly.

3. The variable reluctance motor of claim 2 wherein n is changeable after initial assembly of said phase assembly.

4. The variable reluctance motor according to claim 1, wherein each of said substantially identical phase modules comprises a core including first and second legs positioned on respective sides of a center portion of said core, said phase module further including an electrically conductive coil wrapped about said center portion of said core.

5. The variable reluctance motor according to claim 4, wherein said coil is wrapped about said center portion such that said coil has a substantially fan shape.

6. The variable reluctance motor according to claim 4 wherein said electrically conductive coil is disposed upon a bobbin.

7. The variable reluctance motor according to claim 6 wherein said bobbin is substantially fan shaped.

8. The variable reluctance motor of claim 6 wherein said bobbin is disposed between said legs of said phase module.

9. The variable reluctance motor according to claim 6 including a stator, wherein said bobbin is shaped so that a first surface area of said bobbin is distal to said stator and a second surface area of said bobbin is proximate to said stator, and wherein said first surface area is greater than said second surface area.

10. The variable reluctance motor according to claim 1 wherein said each said phase module is configured to comprise at least one phase unit and wherein each of said phase units is substantially magnetically isolated from the other phase units.

11. The variable reluctance motor according to claim 10 wherein each of said phase units is separated from adjacent phase units by a non-ferromagnetic material.

12. The variable reluctance motor according to claim 1, further comprising a stator and a plurality of stator guides for contacting said stator, said stator guides movable relative to said stator.

13. The variable reluctance motor according to claim 12 wherein said stator guides are affixed to a compliant shaft.

14. The variable reluctance motor according to claim 12 wherein said stator guides are rotatable with respect to said stator.

15. The variable reluctance motor according to claim 14 wherein said stator guides are affixed to a compliant shaft.

16. The variable reluctance motor according to claim 12 wherein said stator guides are slideable with respect to said stator.

17. The variable reluctance motor according to claim 10, wherein the number of said phase units comprising said motor is three.

18. The variable reluctance motor according to claim 4, wherein said core is substantially C-shaped.

19. The variable reluctance motor according to claim 10, wherein at least one of said phase units generates magnetic flux in a direction opposite to the magnetic flux direction in an adjacent phase unit.

20. The variable reluctance motor according to claim 10 wherein the magnetic flux direction in each of said phase units is opposite to the magnetic flux direction in any adjacent phase unit.

21. The variable reluctance motor according to claim 4, wherein said coil comprises a plurality of turns wrapped around said core between said legs such that said legs are substantially free of any of said windings of said coil.

22. The variable reluctance motor according to claim 9, wherein said legs are spaced from each other in a direction that extends parallel to a length of said stator.

23. The variable reluctance motor according to claim 1, wherein said motor further includes a base plate and a top plate.

24. The variable reluctance motor according to claim 23 wherein each of said phase modules is removably secured to said base plate and said top plate so that a total number of phase modules n within said phase assembly can be changed.

25. The variable reluctance motor according to claim 21, further comprising a bobbin configured such that said coil is distributed over a greater surface area in a portion of said bobbin distal to said stator.

26. A variable reluctance motor comprising at least one phase assembly and a stator, said phase assembly comprising a plurality of phase units assemblable between base and top plates, each said phase unit including at least one phase module assembled between said base and top plates.

27. The variable reluctance motor according to claim 26 wherein each phase unit comprises at least two-phase modules situated opposite each other.

28. The variable reluctance motor according to claim 26, wherein each of said phase units includes at least one shaft that is rigidly fixed within an opening in at least one of said plates.

29. The variable reluctance motor according to claim 28 wherein said shaft is rigidly fixed by press fitting so as to obviate the need for adjustment.

30. The variable reluctance motor according to claim 29, wherein said at least one shaft is secured to one of said phase modules.

31. A method for controlling a linear variable reluctance motor, said motor having a plurality of phases comprising the sequential steps of:
supplying electric current to a first electrically conductive coil such that magnetic flux is induced in a first direction in a first phase unit of said linear variable reluctance motor; and
supplying electric current to a second electrically conductive coil in a second phase unit adjacent to said first phase unit such that magnetic flux is induced in a second direction in said second phase unit, said second direction being opposite to said first direction.

32. The method according to claim 31, further comprising the step of supplying electric current to a third electrically conductive coil in a third phase unit adjacent to said second phase unit such that magnetic flux is induced in the first direction in said third phase unit.

33. The method according to claim 32, wherein the first direction is a clockwise direction and the second direction is a counter-clockwise direction.
